(19) United States
(12) Patent Application Publication
(10) Pub. No.: US 2024/0241742 A1
(43) Pub. Date: Jul. 18, 2024

(54) EFFICIENT VM LIVE MIGRATION

(71) Applicant: Nutanix, Inc., San Jose, CA (US)

(72) Inventors: Shivam Kumar, Chapra (IN); Manish Mishra, Bhiwani (IN); Carl Waldspurger, Palo Alto, CA (US)

(21) Appl. No.: 18/153,671

(22) Filed: Jan. 12, 2023

(51) Int. Cl. G06F 9/455

(52) U.S. Cl. CPC G06F 9/45558; G06F 2009/4557

(57) ABSTRACT

An apparatus may include a processor and a non-transitory, computer-readable memory comprising instructions which, when executed by the processor, cause the processor to determine that a first portion of a virtual machine (VM) to be migrated is dirty, determine that a second portion of the VM is dirty, and based on the first portion and the second portion being dirty, mark the first portion, the second portion, and a third portion of the VM as dirty.

### BACKGROUND

Virtual computing systems are widely used in a variety of applications. Virtual computing systems include one or more host machines running one or more virtual machines concurrently. The one or more virtual machines utilize the hardware resources of the underlying one or more host machines. Each virtual machine may be configured to run an instance of an operating system. Modern virtual computing systems allow several operating systems and several software applications to be safely run at the same time on the virtual machines of a single host machine, thereby increasing resource utilization and performance efficiency. Each virtual machine is managed by a hypervisor, host operating system, or virtual machine monitor. Occasionally, a virtual machine or another entity may be migrated from a source site to a target site. Migration is often implemented using an iterative pre-copy approach, where successive iterations of copying VM data copy data which was modified since a most recent data copy.

### SUMMARY

Aspects of the present disclosure relate generally to a computing environment, and more particularly to an apparatus including a processor and a non-transitory, computer-readable memory including instructions which, when executed by the processor, cause the processor determine that a portion of a virtual machine (VM) to be migrated is dirty, determine that a second portion of the VM is dirty, and based on the first portion and the second portion being dirty, mark the first portion, the second portion, and a third portion of the VM as dirty.

In some embodiments, the first portion is a first sub-page of a page of the VM, the second portion is a second sub-page of the page of the VM, and the third portion is multiple sub-pages of the page of the VM.

In some embodiments, the instructions further cause the processor to determine that a fourth portion of the VM is dirty, wherein the first, second, third, and fourth portions are contiguous and, based on the first, second, and fourth portions being dirty, mark a fifth portion of the VM as dirty, wherein the fifth portion is larger than the third portion.

In some embodiments, the first portion is a first sub-page of a page of the VM, the second portion is a second sub-page of the page of the VM, and the third portion is the page of the VM.

In some embodiments, the first portion is a first page of the VM, the second portion is a second page of the VM, and the third portion is a third page of the VM.

In some embodiments, the first portion is a first page of the VM, the second portion is a second page of the VM, and the third portion is a memory region of the VM.

In some embodiments, the processor marks the third portion of the VM as dirty based on the first portion and the second portion being contiguous.

Another aspect of the present disclosure is directed to an apparatus including a processor and a non-transitory, computer-readable memory including instructions which, when executed by the processor, cause the processor to determine a network throughput for migrating a virtual machine (VM) from a source site to a target site, determine an available processing capacity for migrating the VM, determine an expected level of dirtiness of a memory of the VM, based on the network throughput, the available processing capacity, and the expected level of dirtiness of the memory of the VM, determine a granularity level for tracking the memory of the VM, and track portions of the memory of the VM for dirtiness, wherein a size of the portions is based on the granularity level.

In some embodiments, determining the expected level of dirtiness of the memory of the VM is based on one or more historical levels of dirtiness of historical migrations of the VM.

In some embodiments, determining the expected level of dirtiness of the memory of the VM includes determining a first portion dirtiness of a first portion of the memory of the VM, determining a second portion dirtiness of a second portion of the memory of the VM, and based on the first portion dirtiness and the second portion dirtiness, calculating the expected level of dirtiness of the memory of the VM.

In some embodiments, determining the granularity level includes migrating a first subset of the memory of the VM, wherein migrating the first subset includes tracking a dirtiness of first portions of the first subset, wherein a size of the first portions is based on a first preliminary granularity level, determining a first performance metric associated with migrating the first subset, migrating a second subset of the memory of the VM, wherein migrating the second subset includes tracking a dirtiness of second portions of the second subset, and wherein a size of the second portions is based on a second preliminary granularity level, determining a second performance metric associated with migrating the second subset, and based on the first performance metric and the second performance metric, determining the granularity level.

In some embodiments, determining the granularity level includes selecting one of the first preliminary granularity level or the second preliminary granularity level.

In some embodiments, at least one of the first performance metric and the second performance metric includes a migration speed.

In some embodiments, at least one of the first performance metric and the second performance metric includes a processing resource usage.

In some embodiments, determining the granularity level includes selecting a default granularity level.

In some embodiments, the instructions further cause the processor to generate a tracking data structure, wherein tracking the portions of the memory of the VM for dirtiness includes recording, in the tracking data structure, identifiers of the dirtied portions.

In some embodiments, the instructions further cause the processor to generate a page-level tracking data structure, wherein tracking the portions of the memory of the VM for dirtiness includes recording, in the tracking data structure, page-level dirtiness of the memory of the VM.

In some embodiments, the instructions further cause the processor to update the granularity level based on tracking portions of the memory of the VM for dirtiness.

In some embodiments, updating the granularity level includes determining a number of sub-pages of a page of the VM that are dirtied, and, based on the number of dirtied sub-pages exceeding a threshold, reducing the granularity level.

In some embodiments, updating the granularity level includes determining a number of contiguous sub-pages of a page of the VM that are dirtied, and, based on the number of contiguous dirtied sub-pages exceeding a threshold, reducing the granularity level.

Further details of aspects, objects, and advantages of the disclosure are described below in the detailed description, drawings, and claims. Both the foregoing general description and the following detailed description are exemplary and explanatory, and are not intended to be limiting as to the scope of the disclosure. Particular embodiments may include all, some, or none of the components, elements, features, functions, operations, or steps of the embodiments disclosed above. The subject matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 is an example block diagram of a virtual computing system, in accordance with some embodiments of the present disclosure.

FIG. 2 is an example flowchart illustrating a method for migrating a virtual machine (VM) from a source host to a destination host.

FIG. 3 is an example block diagram of a memory of a virtual machine (VM), in accordance with some embodiments of the present disclosure.

FIG. 4 is an example flowchart illustrating a method for dynamically marking portions of VM memory as dirty.

FIG. 5 is an example flowchart illustrating a method for determining a granularity for tracking dirtiness of VM memory.

FIG. 6 illustrates an example distribution of dirtiness in a VM memory.

FIG. 7 illustrates another example distribution of dirtiness in a VM memory.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

Tracking changes to VM memory, dirtied memory, or memory dirtiness at the sub-page level during a live migration has the technical advantage of reducing data transferred during the migration. By increasing a granularity of dirtiness tracking and reducing a size of units transferred, less data is required to be transferred and network traffic may be reduced. As used herein, increasing granularity refers to using finer granularity with a greater number of subdivisions and decreasing granularity refers to using coarser granularity with a lower number of subdivisions. Reducing network traffic may improve a speed of the live migration and cause some migrations to converge which would not converge without tracking dirtiness at the sub-page level. However, tracking memory dirtiness at the sub-page level may increase VM exits, which are computationally costly. Additional advantages are gained by refining the granularity at which memory dirtiness is tracked during a live migration. Determining a granularity level for tracking memory dirtiness during a live migration may yield the advantages of sub-page tracking while mitigating the disadvantages of naive implementation of sub-page tracking, such as increased VM exits. VM exits represent processing overhead during which a virtual CPU does not make any guest progress. By reducing VM exits during live migration, determining the granularity level for tracking memory dirtiness improves the function of a computer by reducing required processing power. By determining the granularity level for tracking memory dirtiness, the same migration can be accomplished using less processing power. Determining the granularity level for tracking memory dirtiness may optimize processor and network usage during the live migration, reducing the time required for the migration and increasing the likelihood of convergence. Furthermore, dynamically adjusting the granularity level during the live migration may further optimize the use of processor and network resources.

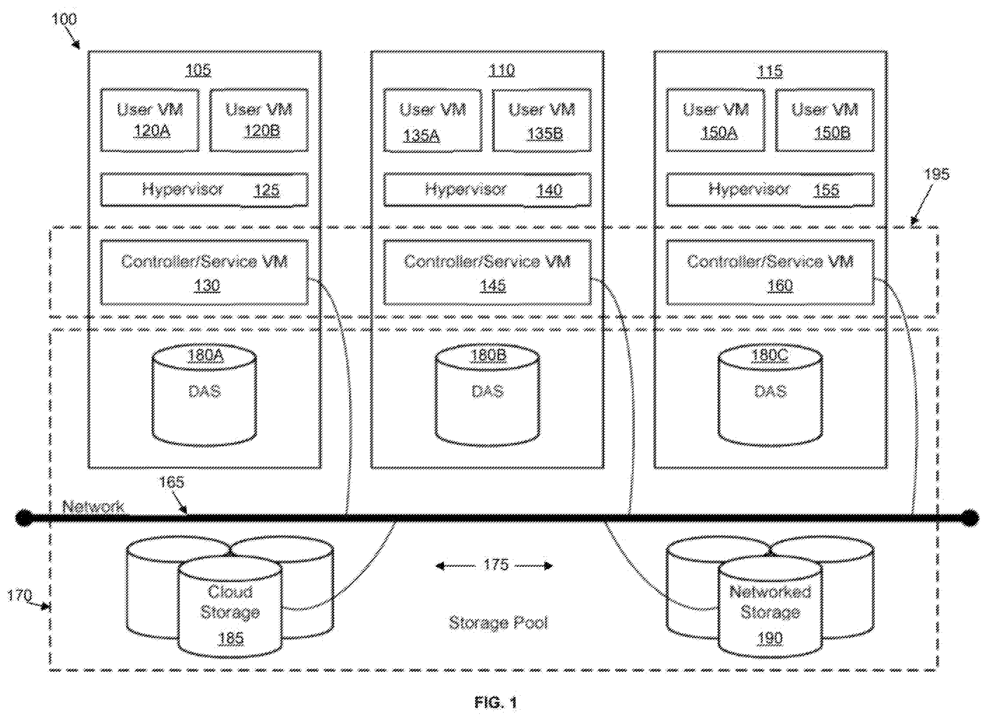

Referring now to FIG. 1 illustrates a virtual computing system 100, in accordance with some embodiments of the present disclosure. The virtual computing system 100 is a hyperconverged system having distributed storage, as discussed below. The virtual computing system 100 includes a plurality of nodes, such as a first node 105, a second node 110, and a third node 115. The first node 105 includes user virtual machines (“user VMs”) 120A and 120B (collectively referred to herein as “user VMs 120”), a hypervisor 125 configured to create and run the user VMs, and a controller/service VM 130 configured to manage, route, and otherwise handle workflow requests between the various nodes of the virtual computing system 100. Similarly, the second node 110 includes user VMs 135A and 135B (collectively referred to herein as “user VMs 135”), a hypervisor 140, and a controller/service VM 145, and the third node 115 includes user VMs 150A and 150B (collectively referred to herein as “user VMs 150”), a hypervisor 155, and a controller/service VM 160. The controller/service VM 130, the controller/service VM 145, and the controller/service VM 160 are all connected to a network 165 to facilitate communication between the first node 105, the second node 110, and the third node 115. Although not shown, in some embodiments, the hypervisor 125, the hypervisor 140, and the hypervisor 155 may also be connected to the network 165.

In some embodiments, the nodes 105, 110, 115 may not include the hypervisors 125, 140, 155. A host operating system may create and run the user VMs without a separate hypervisor. For example, a Linux operating system may create and run the user VMs without a separate hypervisor. In general, virtualization software may be used to create and run the user VMs.

In some embodiments, the nodes 105, 110, 115 may not include the controller/service VMs. The hypervisor, the operating system of the node, or a user-mode application running on the node may manage, route, and otherwise handle workflow requests between the nodes 105, 110, 115 of the virtual computing system 100.

The virtual computing system 100 also includes a storage pool 170. The storage pool 170 may include network-attached storage 175 and direct-attached storage 180A, 180B, and 180C. The network-attached storage 175 may be accessible via the network 165 and, in some embodiments, may include cloud storage 185, as well as local storage area network 190. In contrast to the network-attached storage 175, which is accessible via the network 165, the direct-attached storage 180A, 180B, and 180C may include storage components that are provided within each of the first node 105, the second node 110, and the third node 115, respectively, such that each of the first, second, and third nodes may access its respective direct-attached storage without having to access the network 165.

It is to be understood that only certain components of the virtual computing system 100 are shown in FIG. 1. Nevertheless, several other components that are needed or desired in the virtual computing system to perform the functions described herein are contemplated and considered within the scope of the present disclosure.

Although three of the plurality of nodes (e.g., the first node 105, the second node 110, and the third node 115) are shown in the virtual computing system 100, in other embodiments, greater than or fewer than three nodes may be used. Likewise, although only two of the user VMs (e.g., the user VMs 120, the user VMs 135, and the user VMs 150) are shown on each of the respective first node 105, the second node 110, and the third node 115, in other embodiments, the number of the user VMs on each of the first, second, and third nodes may vary to include either a single user VM or more than two user VMs. Further, the first node 105, the second node 110, and the third node 115 need not always have the same number of the user VMs (e.g., the user VMs 120, the user VMs 135, and the user VMs 150). Additionally, more than a single instance of the hypervisor (e.g., the hypervisor 125, the hypervisor 140, and the hypervisor 155) and/or the controller/service VM (e.g., the controller/service VM 130, the controller/service VM 145, and the controller/service VM 160) may be provided on the first node 105, the second node 110, and/or the third node 115.

In some embodiments, each of the first node 105, the second node 110, and the third node 115 may be a hardware device, such as a server. For example, in some embodiments, one or more of the first node 105, the second node 110, and the third node 115 may be an NX-1000server, NX-3000 server, NX-6000 server, NX-8000 server, etc. provided by Nutanix, Inc. or server computers from Dell, Inc., Lenovo Group Ltd. or Lenovo PC International, Cisco Systems, Inc., etc. In other embodiments, one or more of the first node 105, the second node 110, or the third node 115 may be another type of hardware device, such as a personal computer, an input/output or peripheral unit such as a printer, or any type of device that is suitable for use as a node within the virtual computing system 100.

Each of the first node 105, the second node 110, and the third node 115 may also be configured to communicate and share resources with each other via the network 165 to form a distributed system. For example, in some embodiments, the first node 105, the second node 110, and the third node 115 may communicate and share resources with each other via the controller/service VM 130, the controller/service VM 145, and the controller/service VM 160, and/or the hypervisor 125, the hypervisor 140, and the hypervisor 155. One or more of the first node 105, the second node 110, and the third node 115 may also be organized in a variety of network topologies and may be termed as a “host” or “host machine.”

Also, although not shown, one or more of the first node 105, the second node 110, and the third node 115 may include one or more processing units configured to execute instructions. The instructions may be carried out by a special purpose computer, logic circuits, or hardware circuits of the first node 105, the second node 110, and the third node 115. The processing units may be implemented in hardware, firmware, software, or any combination thereof. The term “execution” is, for example, the process of running an application or the carrying out of the operation called for by an instruction. The instructions may be written using one or more programming language, scripting language, assembly language, etc. The processing units, thus, execute an instruction, meaning that they perform the operations called for by that instruction.

The processing units may be operably coupled to the storage pool 170, as well as with other elements of the first node 105, the second node 110, and the third node 115 to receive, send, and process information, and to control the operations of the underlying first, second, or third node. The processing units may retrieve a set of instructions from the storage pool 170, such as, from a permanent memory device like a read only memory (ROM) device and copy the instructions in an executable form to a temporary memory device that is generally some form of random access memory (RAM). The ROM and RAM may both be part of the storage pool 170, or in some embodiments, may be separately provisioned from the storage pool. Further, the processing units may include a single stand-alone processing unit, or a plurality of processing units that use the same or different processing technology.

With respect to the storage pool 170, the network-attached storage 175 and/or the direct-attached storage 180A-180C may include a variety of types of memory devices. For example, in some embodiments, one or more memories within the storage pool 170 may be provisioned from NAND flash memory devices, NOR flash memory devices, Static Random Access Memory (SRAM) devices, Dynamic Random Access Memory (DRAM) devices, Magnetoresistive Random Access Memory (MRAM) devices, Phase Change Memory (PCM) devices, Resistive Random Access Memory (ReRAM) devices, 3D XPoint memory devices, ferroelectric random-access memory (FeRAM) devices, and other types of memory devices that are suitable for use within the storage pool. Generally speaking, the storage pool 170 may include any of a variety of Random Access Memory (RAM), Read-Only Memory (ROM), Programmable ROM (PROM), Erasable PROM (EPROM), Electrically EPROM (EEPROM), hard disk drives, flash drives, memory tapes, magnetic strips or other types of magnetic storage drives, optical drives, cloud memory, compact disk (CD), digital versatile disk (DVD), smart cards, or any combination of primary and/or secondary memory that is suitable for performing the operations described herein.

The storage pool 170 including the network-attached storage 175 and the direct-attached storage 180A, 180B, and 180C may together form a distributed storage system configured to be accessed by each of the first node 105, the second node 110, and the third node 115 via the network 165, the controller/service VM 130, the controller/service VM 145, and the controller/service VM 160, and/or the hypervisor 125, the hypervisor 140, and the hypervisor 155. In some embodiments, the various storage components in the storage pool 170 may be configured as virtual disks for access by the user VMs 120, the user VMs 135, and the user VMs 150.

Each of the user VMs 120, the user VMs 135, and the user VMs 150 is a software-based implementation of a computing machine. The user VMs 120, the user VMs 135, and the user VMs 150 emulate the functionality of a physical computer. Specifically, the hardware resources, such as processing unit, memory, storage, etc., of the underlying computer (e.g., the first node 105, the second node 110, and the third node 115) are virtualized or transformed by the respective hypervisor 125, the hypervisor 140, and the hypervisor 155, into the underlying support for each of the user VMs 120, the user VMs 135, and the user VMs 150 that may run its own operating system and applications on the underlying physical resources just like a real computer. By encapsulating an entire machine, including CPU, memory, operating system, storage devices, and network devices, the user VMs 120, the user VMs 135, and the user VMs 150 are compatible with most standard operating systems (e.g. Windows, Linux, etc.), applications, and device drivers. Thus, each of the hypervisor 125, the hypervisor 140, and the hypervisor 155 is a virtual machine monitor that allows a single physical server computer (e.g., the first node 105, the second node 110, third node 115) to run multiple instances of the user VMs 120, the user VMs 135, and the user VMs 150, with each user VM sharing the resources of that one physical server computer, potentially across multiple environments. For example, each of the hypervisor 125, the hypervisor 140, and the hypervisor 155 may allocate memory and other resources to the underlying user VMs (e.g., the user VMs 120, the user VMs 135, and the user VMs 150) from the storage pool 170 to perform one or more functions.

By running the user VMs 120, the user VMs 135, and the user VMs 150 on each of the first node 105, the second node 110, and the third node 115, respectively, multiple workloads and multiple operating systems may be run on a single piece of underlying hardware computer (e.g., the first node, the second node, and the third node) to increase resource utilization and manage workflow. When new user VMs are created (e.g., installed) on the first node 105, the second node 110, and the third node 115, each of the new user VMs may be configured to be associated with certain hardware resources, software resources, storage resources, and other resources within the cluster 100 to allow those virtual VMs to operate as intended.

The user VMs 120, the user VMs 135, the user VMs 150, and any newly created instances of the user VMs are controlled and managed by their respective instance of the controller/service VM 130, the controller/service VM 145, and the controller/service VM 160. The controller/service VM 130, the controller/service VM 145, and the controller/service VM 160 are configured to communicate with each other via the network 165 to form a distributed system 195. Each of the controller/service VM 130, the controller/service VM 145, and the controller/service VM 160 may be considered a local management system configured to manage various tasks and operations within the cluster 100. For example, in some embodiments, the local management system may perform various management related tasks on the user VMs 120, the user VMs 135, and the user VMs 150.

The hypervisor 125, the hypervisor 140, and the hypervisor 155 of the first node 105, the second node 110, and the third node 115, respectively, may be configured to run virtualization software, such as, ESXi from VMware, AHV from Nutanix, Inc., XenServer from Citrix Systems, Inc., etc. The virtualization software on the hypervisor 125, the hypervisor 140, and the hypervisor 155 may be configured for running the user VMs 120, the user VMs 135, and the user VMs 150, respectively, and for managing the interactions between those user VMs and the underlying hardware of the first node 105, the second node 110, and the third node 115. Each of the controller/service VM 130, the controller/service VM 145, the controller/service VM 160, the hypervisor 125, the hypervisor 140, and the hypervisor 155 may be configured as suitable for use within the cluster 100.

The network 165 may include any of a variety of wired or wireless network channels that may be suitable for use within the cluster 100. For example, in some embodiments, the network 165 may include wired connections, such as an Ethernet connection, one or more twisted pair wires, coaxial cables, fiber optic cables, etc. In other embodiments, the network 165 may include wireless connections, such as microwaves, infrared waves, radio waves, spread spectrum technologies, satellites, etc. The network 165 may also be configured to communicate with another device using cellular networks, local area networks, wide area networks, the Internet, etc. In some embodiments, the network 165 may include a combination of wired and wireless communications.

Again, it is to be understood again that only certain components and features of the cluster 100 are shown and described herein. Nevertheless, other components and features that may be needed or desired to perform the functions described herein are contemplated and considered within the scope of the present disclosure. It is also to be understood that the configuration of the various components of the cluster 100 described above is only an example and is not intended to be limiting in any way. Rather, the configuration of those components may vary to perform the functions described herein.

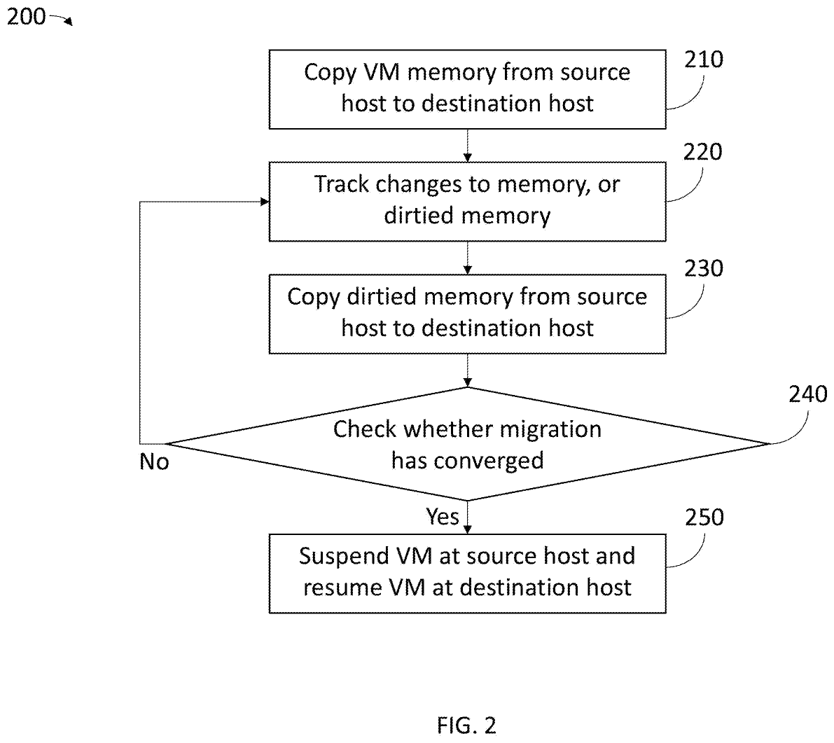

FIG. 2 is an example flowchart illustrating a method 200 for migrating a virtual machine (VM) from a source host to a destination host. In some embodiments, the source host, also called the source site, may be the first node 105, the second node 110, or the third node 115 of the cluster 100 of FIG. 1, or another node. The destination host, also called the target site, may be the first node 105, the second node 110, or the third node 115 of the cluster 100 of FIG. 1, or another node, where the destination host is different from the source host. In some embodiments, the method 200 may be performed by the hypervisor 125 and/or other components of FIG. 1. The method 200 may include more or fewer operations than shown. The operations shown may be performed in the order shown, in a different order, or concurrently.

The method 200 may be a live migration, as the VM continues to run during the migration. At 210, VM memory is copied from the source host to the destination host. In some embodiments, the entire VM memory is copied from the source host to the destination host. The source host may be the host or node where the VM is currently running, and the destination host may be the VM to which the VM is being migrated. As the VM is running, changes are made to the VM memory after the VM memory is copied from the source host to the destination host. At 220, the changes to the VM memory are tracked. Memory that has been changed since the VM memory was copied from the source host to the destination host at 210 is marked as “dirty.” At 230, the dirtied memory is copied from the source host to the destination host. Less than the entire VM memory is copied from the source host to the destination host, as only dirtied memory is copied. At 240, whether the migration has converged is checked. The migration may converge when the amount of remaining dirty memory is sufficiently small to suspend VM execution at the source host and complete the transfer of the VM memory to the destination host. In some embodiments, the migration converges when the remaining dirty memory is below a predefined threshold. In some embodiments, the predefined threshold is defined by an amount of time required to transfer the remaining dirty memory to the destination host. For example, the migration may converge when a time required to copy the remaining dirty memory from the source host to the destination host is less than 100 milliseconds. If the migration has not converged, another iteration of tracking dirtied memory begins at 220. If the migration has converged, at 250 the VM is suspended at the source host, the remaining memory is copied form the source host to the destination host, and the VM is resumed at the destination host 250. In some embodiments, the migration fails to converge, and the migration may be aborted. For example, modifications of large amounts of memory between iterations of copying may prevent the remaining memory from being small enough for the migration to converge. In another example, low-bandwidth network connections may constrain a speed at which memory can be copied from the source host to the destination host, preventing the time required to copy the remaining dirty memory from the source host to the destination source from being below a predetermined threshold. The predetermined threshold may be based on a speed at which the VM dirties memory, meaning that the VM may dirty more memory than is copied from the source host to the destination host, preventing migration convergence.

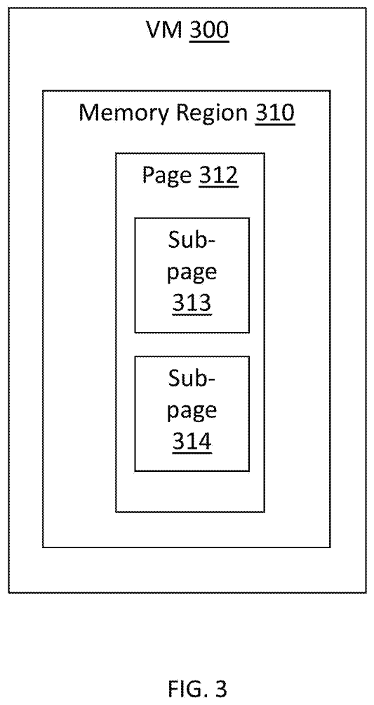

FIG. 3 is an example block diagram of a memory 300 of a virtual machine (VM), in accordance with some embodiments of the present disclosure. In some embodiments, the VM memory 300 may be a memory of the user VM 120A, 120B, 135A, 135B, 150A, or 150B. The VM memory 300 may include a memory region 310. The memory region 310 may be a naturally aligned region of memory of the VM. The memory region 310 may represent any amount of contiguous memory. In some embodiments, the memory region 310 may be about 2 MB. In some embodiments, the VM memory may include a plurality of memory regions. The memory region 310 may include a page 312. In some embodiments, the page is about 4 KB. In some embodiments, the memory region 310 may include a plurality of pages. For example, a 2 MB memory region may include 512 4 KB pages. The page 312 may include a first sub-page 313 and a second sub-page 314. In some embodiments, the first sub-page 313 and the second sub-page 314 may each be about 128 B. In some embodiments, the page 312 may include a plurality of sub-pages. In some embodiments, the page 312 may include 32 sub-pages. VM writes alter the VM memory 300. VM writes may alter the VM memory 300 during migration, resulting in dirtied memory that is tracked, as in the method 200 of FIG. 2. VM writes can be tracked at the VM level, the memory region level, the page level, and the sub-page level. As discussed herein, the term “page-level” refers to information pertaining to pages of a VM. For example, tracking page-level dirtiness means tracking which pages of the VM are dirty. As discussed herein, the terms “sub-page level” refers to information pertaining to sub-pages of pages of a VM. For example, tracking sub-page level dirtiness means tracking which sub-pages of a page of the VM are dirty.

Conventional migration systems and methods track VM writes at the page level. Generally, a page of a VM is the smallest unit of virtual-to-physical translation supported by processor hardware. For example, a 4 KB page is the smallest unit of virtual-to-physical translation supported by x86 processors. A hardware extension may be used to track VM writes at the sub-page level. A sub-page write permission (SPP) feature may allow software to track writes separately to each sub-page of a page of a VM. For example, SPP allows virtualization software to track writes to each of the 32 naturally aligned 128-byte sub-pages within a single 4 KB page. SPP may be used to identify VM writes that occur during migration of a VM to identify dirty memory, or memory that has been altered since a most recent copy of the VM memory. SPP may be used to track dirtied sub-pages. For example, SPP may be used to track a VM write to the page 312 in the first sub-page 313 such that the first sub-page 313 is marked as dirty and the second sub-page 314 is not marked as dirty. Marking the first sub-page 313 as dirty and not marking the second sub-page 314 as dirty has the advantage of requiring less memory to be copied from a source host to a destination host relative to marking the entire page 312 as dirty, increasing chances of the migration converging.

In some embodiments, a data structure is generated for tracking dirtied memory. In some embodiments, a page-level data structure is generated for tracking which pages of the VM 300 are dirty. In an example, the page-level data structure may be a page-level bitmap which indicates which pages need to be copied to the destination host in the current iteration. In some embodiments, a second data structure is generated for tracking which pages have sub-page information, or for which pages sub-page-level information is available. In an example, the second data structure may be a bitmap which indicates whether sub-page level dirtiness information is available for a page. In some embodiments, a sub-page data structure is generated for tracking which sub-pages of a page are dirty. In some embodiments, a sub-page-level bitmap can be used to track dirtied sub-pages. For example, if each page has 4 sub-pages, then a bitmap four times the page-level bitmap can be used to track dirtying for each sub-page. In some embodiments, the sub-page data structure may be indexed by page number. The sub-page data structure may correspond to the second data structure which tracks for which pages sub-page-level information is available. For example, SPP may require generating a sub-page permission table (SPPT), which is organized in a manner similar to a hierarchical page table. Each leaf entry contains a sub-page permission vector; a bit associated with each of the 32 sub-pages indicates whether or not the sub-page can be written without causing a VM-exit that traps into the virtualization system software to be processed.

In some embodiments, one or more data structures are not generated for tracking dirtied memory. Hardware-based SPP tables which identify dirtied sub-pages may be used to incrementally copy data from the source host to the destination host. The hypervisor may iterate over each page having dirtied memory, capturing the sub-page dirty information from the SPP table before resetting the SPP table and transferring the modified sub-pages to the destination host. At a start of each live migration iteration, each subpage may be write-protected in SPP page tables. When a sub-page is marked as dirty during live migration iterations, sub-page protection may be removed. Thus, marking sub-pages as dirty may include identifying for which sub-pages sub-page protection is removed. This approach allows for use of a bitmap tracking page-level dirtiness while still leveraging sub-page level information without generating a separate sub-page level data structure.

In some embodiments, a hash table containing fewer entries than the number of pages may be implemented as a fixed-size array of 32-bit values, indexed by page number modulo the table size. Hash collisions due to aliasing may be handled conservatively by simply updating the same entry; the resulting value will be the bitwise-OR of dirty sub-pages across all aliased dirty pages (possibly yielding false positives for some “dirty” sub-pages). For example, if only about 10% of pages are expected to be dirty (some sub-pages dirty) but not fully dirty (all sub-pages dirty), this approach would require, per-page, one bit for the page-level dirty bitmap, one bit for the has-subpage-info bitmap, and 0.1×32=3.2 bits for the hash table—for a total of only 5.2 bits per page, instead of 32 for a naive sub-page-level dirty bitmap. In other embodiments, other approximate probabilistic data structures may be employed, such as a Bloom filter.

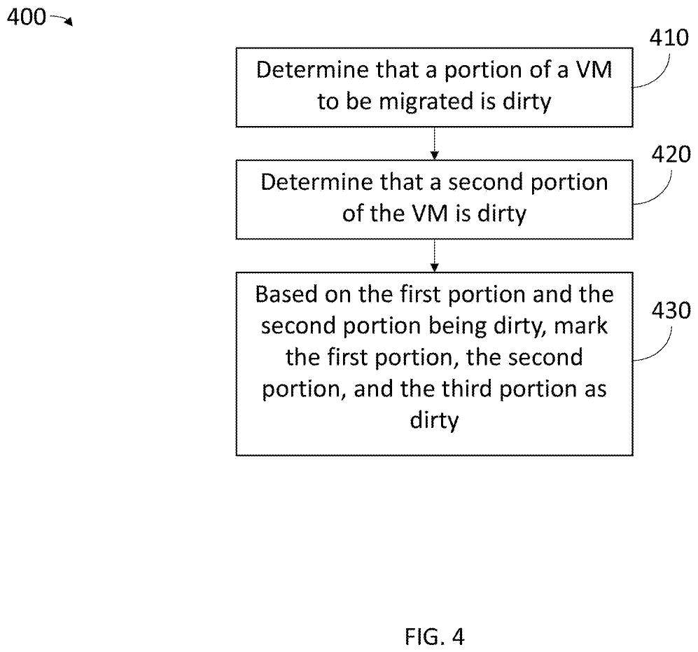

FIG. 4 is an example flowchart illustrating a method 400 for dynamically marking portions of a VM memory as dirty. In some embodiments, the method 400 may be performed by the hypervisor 125 and/or other components of FIG. 1. The method 400 may include more or fewer operations than shown. The operations shown may be performed in the order shown, in a different order, or concurrently. Dynamically marking portions of the VM memory as dirty serves to adjust a granularity of marking the VM memory as dirty and/or tracking dirtiness of the VM memory. SPP allows for tracking dirtiness of the VM memory at the sub-page level, but tracking dirty sub-pages introduces its own costs, including both memory and CPU overheads, which could potentially outweigh the benefits associated with higher granularity. Tracking dirtiness for every sub-page would incur VM-exits for every sub-page that is modified, which means that overwriting the contents of a page would result in many more VM-exits per page than the single VM-exit per page incurred when using ordinary write protection at page granularity. For example, dirty tracking at the sub-page level would incur VM-exits for every 128-byte sub-page that is modified of a 4 KB page. In this example, overwriting the contents of the 4 KB page would result in 32 VM-exits, compared to a single VM-exit when using ordinary write protection at page granularity. The increased number of VM exits may cause slowdowns for the VM. Tracking memory dirtiness at the sub-page level also requires larger data structures relative to tracking memory dirtiness at the page level. For example, tracking 32 sub-pages per page requires a 32× increase in the size of data structures used to track modifications to memory across live-migration iterations. Dynamically marking portions of the VM memory as dirty may allow the granularity of tracking memory dirtiness to be optimized during migration, such that a performance and speed of the migration may be improved while limiting an impact on VM performance and memory overheads. Dynamically marking portions of the VM memory as dirty may result in tracking dirtiness at the page-level, at the sub-page level, or at an intermediate level. An ideal granularity may vary depending on memory access patterns of the VM and the available network bandwidth between the source and destination hosts. The ideal granularity may also vary across different memory regions and individual pages and may change across pre-copy iterations.

At 410, it is determined that a first portion of a VM to be migrated is dirty. At 420, it is determined that a second portion of the VM is dirty. At 430, based on the first portion and the second portion being dirty, the first portion, the second portion, and the third portion are marked as dirty. In some embodiments, the first portion is a sub-page of a page of the VM, the second portion is a second sub-page of the VM, and the third portion is multiple sub-pages of the page of the VM. For example, a hypervisor of the VM may track changes in the first sub-page and the second sub-page, and, without tracking changes in the multiple sub-pages of the third portion, mark, in a tracking data structure, the multiple sub-pages of the third portion as dirty. This has the advantage of reducing VM exits while retaining granularity of dirtiness tracking. Various heuristics may be applied for selecting the multiple sub-pages of the third portion. For example, changes tracked in SPP vectors in an SPPT may be applied to a software-maintained tracking data structure.

In some embodiments, the granularity of dirtiness tracking may be gradually reduced based on determinations of dirtiness in successive sub-pages. Increasingly larger numbers of sub-pages may be marked as dirty based on a heuristic of contiguous sub-pages being dirty. In an example, a first sub-page is determined to be dirty, and the first sub-page is marked as dirty. A second sub-page contiguous with the first sub-page is determined to be dirty and the second sub-page as well as a third sub-page contiguous with the second sub-page are marked as dirty. A fourth sub-page contiguous with the third sub-page is determined to be dirty and the fourth sub-page as well as contiguous fifth and sixth sub-pages are marked as dirty. In some embodiments, portions of the VM memory other than individual sub-pages may be used. In some embodiments, the portions of the VM memory marked as dirty may increase faster or slower than in the above example. In some embodiments, the portions of VM memory may be in multiples of 128 B such as 256 B, 512 B, 1 KB, 2 KB, 4 KB, where a sub-page is 128 B. In other embodiments, the portions of VM memory may be in other sizes, such as 384 B where a sub-page is 128 B. In some embodiments, the portions of the VM memory may be the same size within the page. In other embodiments, the portions of the VM memory may be different sizes within the page. In an example, a page may be split into eleven portions, with ten portions for the first thirty sub-pages being 384 B and a portion for the last two sub-pages being 256 B.

In some embodiments the first portion is a first sub-page of a page of the VM, the second portion is a second sub-page of the VM, and the third portion is the page of the VM. This approach may be based on the heuristic that multiple dirty sub-pages mean that the page should be marked as dirty. This approach may also be based on a determination that tracking dirtiness for a number of sub-pages of a page beyond a predetermined threshold is less efficient than tracking dirtiness for the entire page. For example, the predetermined threshold number of sub-pages may be five sub-pages, such that subsequent VM exits may reduce performance more than higher-granularity dirtiness tracking improves performance. In this example, once five sub-pages have been tracked as dirty, the page may be marked as dirty to prevent subsequent VM exits. Additionally, marking the page as dirty reduces the memory requirements for tracking dirtiness in the VM memory. In some embodiments, the first portion is the page of the VM, the second portion is a sub-page of a second page of the VM, which is contiguous with the page of the VM, and the third portion is the second page of the VM. This approach may be based on the heuristic that contiguous pages are likely to be fully dirty if at least one sub-page is dirty since memory copies or initialization often span multiple pages. The term “contiguous” may refer to contiguity in any address space, including guest-virtual space and guest-physical space, where the guest-virtual space maps to the guest-physical space. Pages that are contiguous in the guest-virtual space may be discontiguous in the guest-physical space. Pages may be accessed sequentially due to being contiguous in the guest-virtual space. For example, a data copy that spans multiple pages causes multiple contiguous pages to be accessed sequentially. Heuristics for predicting dirtiness of memory may be based on spatial locality (contiguity in guest-physical space) or temporal locality (pages that are accessed in succession). In an example, sub-page one of a page is tracked as dirty and sub-page two is tracked as dirty, causing sub-page three to be marked as dirty. Sub-page four is tracked as dirty, causing sub-pages five and six to be tracked as dirty. This continues until the entire page is marked as dirty. Then, sub-page 1 of a second page accessed subsequent to the page is tracked as dirty, causing the second page to be marked as dirty.

In some embodiments, the first portion is a first page of the VM, the second portion is a second page of the VM, and the third portion is a third page of the VM. In some embodiments, the first page, the second page, and the third page are contiguous. Marking the third page as dirty based on the first and second pages being dirty may be based on the heuristic that contiguous pages are likely to be dirty since memory copies or initialization often span multiple pages. In some embodiments, the first page, the second page, and the third page were accessed successively. Marking the third page as dirty based on the first and second pages being dirty may be based on the heuristic that changes are applied to successively accessed pages or the heuristic that pages that are accessed after pages that are fully dirty are also likely to be fully dirty. Additionally, marking the pages as dirty eliminates the need to track sub-page dirtiness of the pages, reducing the memory requirements for tracking the dirtiness of the VM memory. As discussed above, heuristics for predicting dirtiness of memory may be based on spatial locality (contiguous pages) and/or temporal locality (successively accessed pages). Spatial locality and temporal locality may be used in heuristics for portions of memory of any size.

In some embodiments, the first portion may be a first page of the VM, the second portion may be a second page of the VM, and the third portion may be a memory region of the VM. In some embodiments, the memory region includes the first page and the second page. Marking the memory region as dirty based on the first and second pages being dirty may be based on the heuristic that a memory region containing contiguous dirty pages, or a threshold number of dirty pages is dirty. In some embodiments, the memory region may be marked as dirty in order to reduce the memory required to track dirtiness in the VM. For example, if the memory region is marked as dirty, a leaf in an SPPT for tracking dirtiness may be deallocated, saving memory space. In some embodiments, the memory region may be marked as dirty based on a determination that the memory cost of tracking page-level dirtiness in the memory region outweighs improved migration performance from tracking page-level dirtiness in the memory region.

In other embodiments, the leaf in the SPPT table may be deallocated based on few subpages being dirtied, e.g., a density of bits set in the leaf is low. A bit set in the leaf may correspond to a sub-page that is not dirty and a bit not set in the leaf may correspond to a sub-page that is dirty. Based on the density of bits in the leaf being below a predetermined threshold, the leaf may be deallocated in order to reduce the memory required to track dirtiness in the VM. The VM pages for which sub-page level dirtiness was tracked in the leaf may still be marked as dirty at the page level in a page-level tracking data structure.

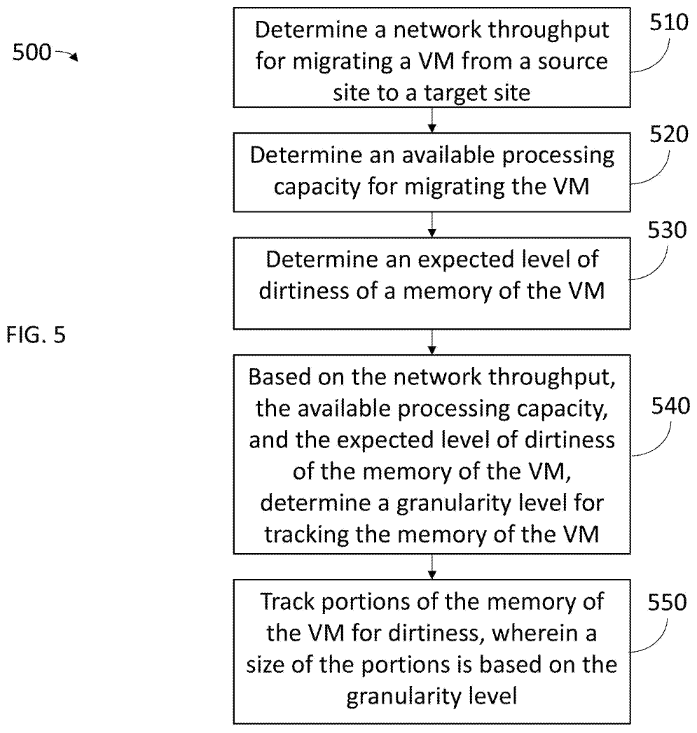

FIG. 5 is an example flowchart illustrating a method 500 for determining a granularity for tracking dirtiness of VM memory. In some embodiments, the method 500 may be performed by the hypervisor 125 and/or other components of FIG. 1. The method 500 may include more or fewer operations than shown. The operations shown may be performed in the order shown, in a different order, or concurrently. In some embodiments, the method 500 may determine a starting or default granularity for tracking VM memory dirtiness. The method 500 may be combined with or used in conjunction with the method 400 of FIG. 4. For example, the method 500 may be used to determine the default granularity for tracking dirtiness and the method 400 may be used to dynamically adjust the default granularity to determine a granularity for particular portions of pages, pages, or memory regions during migration, as discussed in conjunction with FIG. 4.

At 510, a network throughput is determined for migrating a VM from a source site to a target site. The network throughput may include an available bandwidth and network transfer speed. Network throughput may be more important in some circumstances and less important in other circumstances. For example, if network throughput is severely constrained, such as may be the case in a wide area network (WAN), saving network traffic may be critical, and may even allow live migrations that wouldn't converge with traditional page-level dirty tracking to complete. In this example, the benefit of reducing network traffic by only transferring the smallest possible unit of data, such as a sub-page, may be important to migration performance and/or convergence. In another example, For VMs with small memory sizes, or uncongested networks with high effective throughput, network throughput may be less important and traditional page-level migration may be preferred over sub-page-level migration to avoid the risk of negatively impacting guest performance due to higher VM-exit rates with sub-page granularities. In some embodiments, multiple small network transfers may be aggregated for transfer using a scatter-gather I/O (aka vectored I/O). For example, network transfers of a single sub-page may have a relatively high processing overhead to data transferred ratio. Multiple single sub-page network transfers may be aggregated using a scatter gather so that they are transferred together, reducing the processing overhead to data transferred ratio.

At 520, an available processing capacity for migrating the VM is determined 520. The available processing capacity for migrating the VM may be used for determining the dirtiness of a VM memory, tracking the dirtiness of the VM memory, and transferring the copied memory. VM-exits which are incurred as dirtiness is determined and marked, are associated with high processing overhead. Thus, if the available processing capacity is low, a lower (coarser) granularity may be preferred to avoid reduced VM performance during the VM migration.

At 530, an expected level of dirtiness of a memory of the VM is determined. The expected level of dirtiness of the memory may include a proportion of pages of the VM that are dirty, and proportion of sub-pages of the pages and/or the VM that are dirty. In some embodiments, the expected level of dirtiness may include an initial level of dirtiness for the first copy iteration as well as subsequent levels of dirtiness for subsequent pre-copy iterations. In some embodiments, the expected level of dirtiness is based on levels of dirtiness in previous pre-copy iterations. In some embodiments, the expected level of dirtiness is based on one or more historical levels of dirtiness of historical migrations of the VM. In other embodiments, the expected level of dirtiness is based on one or more historical levels of dirtiness of historical migrations of similar VMs, such as VMs in the same cluster as the VM, or VMs running similar applications as the VM. In some embodiments, determining the expected level of dirtiness of the VM memory includes sampling portions of the VM memory, determining the levels of dirtiness of the sampled portions, and calculating the expected level of dirtiness. In an example, a first dirtiness level of a first portion is determined, a second dirtiness level of a second portion is determined, and, based on the first dirtiness level and the second dirtiness level, calculating the expected level of dirtiness. In other examples, different numbers of portions may be sampled. The portions may have the same size or different sizes. The portions may be contiguous or non-contiguous.

At 540, a granularity level for tracking the memory of the VM is determined based on the network throughput, the available processing capacity, and the expected level of dirtiness of the memory of the VM. In some embodiments, determining the granularity level includes conducting a quantitative cost-benefit check regarding an expected increase in VM exits (cost) versus the expected decrease in network data transfers (benefit) to estimate the best granularity. A number of VM exits and the volume of network data transfers may be affected by the expected level of dirtiness and the granularity. The granularity level may depend upon the relative importance or constraints imposed by the network throughput and the available processing capacity.

In some embodiments, determining the granularity level includes migrating a first subset of the VM memory by tracking dirtiness of the first subset based on a first preliminary granularity level, determining a first performance metric associated with migrating the first subset, migrating a second subset of the VM memory by tracking dirtiness of the second subset based on a second preliminary granularity level, determining a second performance metric associated with migrating the second subset, and, based on the first performance metric and the second performance metric, determining granularity level. In some embodiments, the first and second performance metrics may include a migration speed and/or a VM guest performance or processing resource usage. The migration speed may be increased by transferring smaller portions of the VM at a time and thus more efficiently using the network throughput, and the VM guest performance or processing resource usage may be improved by incurring fewer VM exits and using less of the available processing capacity. In some embodiments, determining the granularity level may include selecting one of the first preliminary granularity level or the second preliminary granularity level. In some embodiments, determining the granularity level includes selecting a default granularity level. The default granularity level may be a default granularity level for VMs of a particular type, of a particular cluster, or running a particular application.

In an example, ten pages of the VM are migrated using a granularity of 256 B, or one-sixteenth of a 4 KB page. Ten other pages of the VM are migrated using a granularity of 2 KB, or one half of a 4 KB page. The granularity of 2 KB is selected for the migration of the VM based on the speed of migration being higher and the processing resource usage being lower for the granularity of 2 KB.

In some embodiments, the method 500 further includes generating a tracking data structure, where tracking the portions of the memory of the VM for dirtiness includes recording, in the tracking data structure, identifiers of the dirtied portions. The data structure may be one or more data structures as discussed herein for tracking page-level and/or sub-page-level memory dirtiness.

In some embodiments, the method 500 may further include updating the granularity level based on tracking portions of the memory of the VM for dirtiness, as discussed herein. Updating the granularity level based on tracking portions of the memory of the VM for dirtiness may include determining a number of sub-pages of a page that are dirtied, comparing the number of sub-pages that are dirtied to a predetermined threshold, and, based on the number of dirtied sub-pages exceeding the threshold, reducing the granularity level. In some embodiments, the granularity level may be reduced based on a number of contiguous dirty sub-pages exceeding a predetermined threshold.

In some embodiments, the method 500 may omit operations 510 and 520. At 540, the granularity level may be determined based on the expected level of dirtiness, without taking into account the available processing capacity or network throughput.

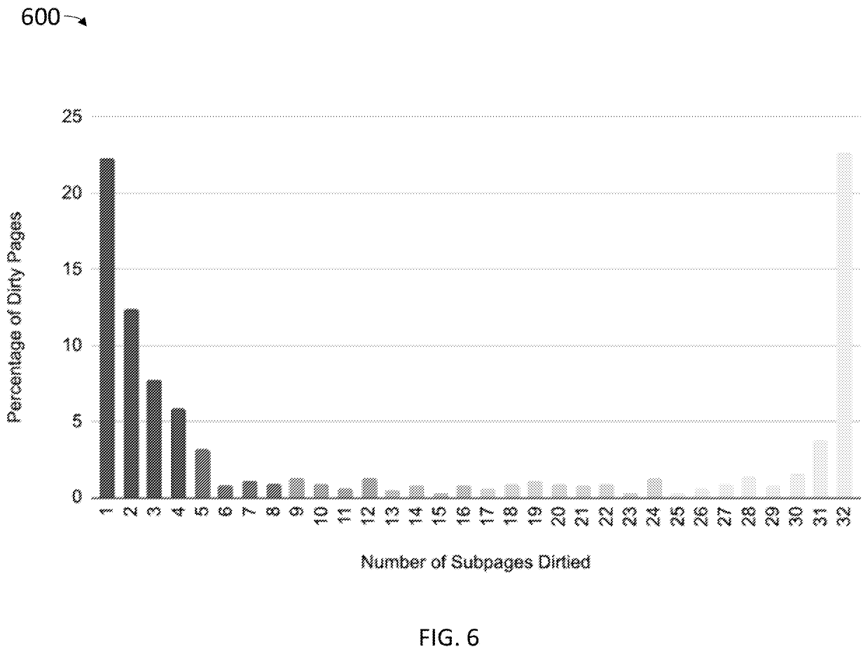

FIG. 6 illustrates an example distribution 600 of dirtiness in a VM memory. The distribution 600 may be an example of historical dirtiness of VM memory as discussed in conjunction with FIG. 5. The distribution 600 may be a dirtiness of a sample portion of the VM memory. The distribution 600 may be used in determining the expected level of dirtiness of the VM memory in 530 of FIG. 5. The distribution 600 may show how dirty the pages of the VM memory are. The distribution 600 may show what proportion of dirty pages have what number of sub-pages dirty, where each page has 32 sub-pages. The distribution 600 may show that about 22% of dirty pages have only one dirty sub-page and that about 22% of dirty pages are fully dirty (all sub-pages are dirty). Based on the distribution, a granularity for tracking dirtiness during a migration may be determined, as discussed in FIG. 5. For example, the high proportion of pages with one or few sub-pages dirtied may weigh in favor of high (fine) granularity. Tracking dirtiness at the sub-page level may reduce network traffic as only dirtied sub-pages need to be transferred, and pages with few sub-pages incur few VM exits. However, the optimal granularity depends upon the network throughput and the available processing capacity, as discussed in conjunction with FIG. 5. Lower network throughput weighs in favor of higher (finer) granularity, to avoid network bottlenecking, while lower available processing capacity weighs in favor of lower (coarser) granularity, to prevent CPU bottlenecking. Dynamic adjustment of the granularity may be performed to reduce the number of VM exits for pages expected to be fully dirty. In some embodiments, additional sampling or historical information may be used to estimate which pages have few dirtied sub-pages and which pages are fully-dirty.

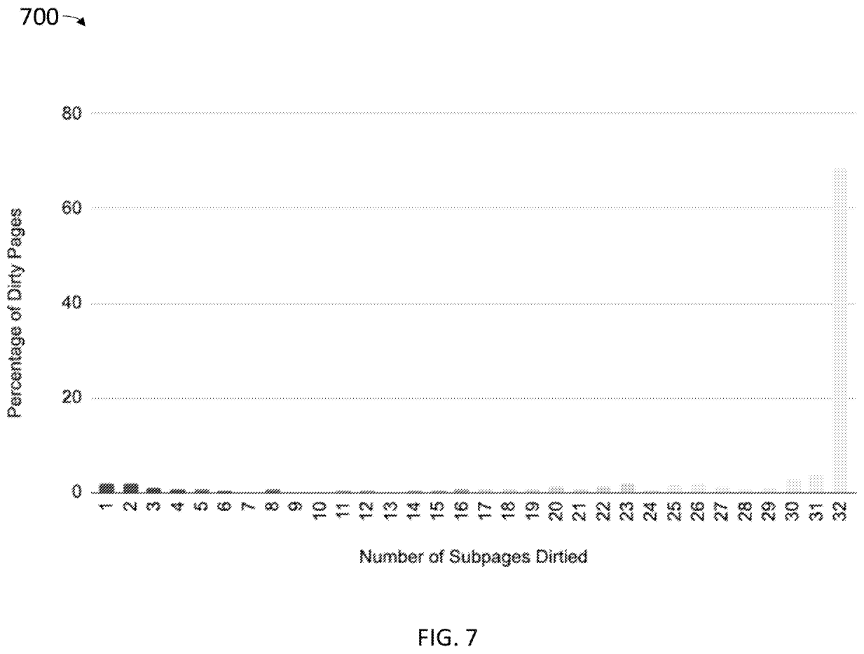

FIG. 7 illustrates another example distribution 700 of dirtiness in a VM memory. The distribution 700 may be an example of historical dirtiness of VM memory as discussed in conjunction with FIG. 5. The distribution 700 may be a dirtiness of a sample portion of the VM memory. The distribution 700 may be used in determining the expected level of dirtiness of the VM memory in 530 of FIG. 5. The distribution 700 may show how dirty the pages of the VM memory are. The distribution 700 may show what proportion of dirty pages have what number of sub-pages dirty, where each page has 32 sub-pages. The distribution 700 may show that about 70% of dirty pages are fully dirty (all sub-pages are dirty). Based on the distribution 700, a granularity for tracking dirtiness during a migration may be determined, as discussed in FIG. 5. For example, the high proportion of fully-dirty pages may weigh in favor of low (coarse) granularity. Tracking dirtiness at the page level may reduce unnecessary VM exits, as a high proportion of dirty pages are fully dirty, meaning there is no benefit to tracking dirtiness for those pages at a granularity higher (finer) than the page level. Dynamic adjustment of the granularity may be performed to reduce the number of VM exits for the fully-dirty pages. For example, multiple pages may be marked as fully-dirty as discussed in conjunction with FIG. 4.

It is to be understood that any examples used herein are simply for purposes of explanation and are not intended to be limiting in any way.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to disclosures containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the disclosure be defined by the claims appended hereto and their equivalents.

What is claimed:

1. An apparatus comprising a processor and a non-transitory, computer-readable memory comprising instructions which, when executed by the processor, cause the processor to:
determine that a first portion of a virtual machine (VM) to be migrated is dirty;
determine that a second portion of the VM is dirty; and
based on the first portion and the second portion being dirty, mark the first portion, the second portion, and a third portion of the VM as dirty.

2. The apparatus of claim 1, wherein the first portion is a first sub-page of a page of the VM, the second portion is a second sub-page of the page of the VM, and the third portion is multiple sub-pages of the page of the VM.

3. The apparatus of claim 2, wherein the instructions further cause the processor to:
determine that a fourth portion of the VM is dirty, wherein the first, second, third, and fourth portions are contiguous; and
based on the first, second, and fourth portions being dirty, mark a fifth portion of the VM as dirty, wherein the fifth portion is larger than the third portion.

4. The apparatus of claim 1, wherein the first portion is a first sub-page of a page of the VM, the second portion is a second sub-page of the page of the VM, and the third portion is the page of the VM.

5. The apparatus of claim 1, wherein the first portion is a first page of the VM, the second portion is a sub-page of a second page of the VM, and the third portion is the second page of the VM.

6. The apparatus of claim 1, wherein the first portion is a first page of the VM, the second portion is a second page of the VM, and the third portion is a memory region of the VM.

7. The apparatus of claim 1, wherein the processor marks the third portion of the VM as dirty based on the first portion and the second portion being contiguous.

8. The apparatus of claim 1, wherein the processor marks the third portion of the VM as dirty based on the first portion and the second portion being accessed successively.

9. An apparatus comprising a processor and a non-transitory, computer-readable memory comprising instructions which, when executed by the processor, cause the processor to:
determine a network throughput for migrating a virtual machine (VM) from a source site to a target site;
determine an available processing capacity for migrating the VM;
determine an expected level of dirtiness of a memory of the VM;
based on the network throughput, the available processing capacity, and the expected level of dirtiness of the memory of the VM, determine a granularity level for tracking the memory of the VM; and
track portions of the memory of the VM for dirtiness, wherein a size of the portions is based on the granularity level.

10. The apparatus of claim 9, wherein determining the expected level of dirtiness of the memory of the VM is based on one or more historical levels of dirtiness of historical migrations of the VM.

11. The apparatus of claim 9, wherein determining the expected level of dirtiness of the memory of the VM comprises:
sampling a first portion of the memory of the VM to determine a first portion dirtiness of the first portion;
sampling a second portion of the memory of the VM to determine a second portion dirtiness of the second portion; and
based on the first portion dirtiness and the second portion dirtiness, calculating the expected level of dirtiness of the memory of the VM.

12. The apparatus of claim 9, wherein determining the granularity level comprises:
migrating a first subset of the memory of the VM, wherein migrating the first subset comprises tracking a dirtiness of first portions of the first subset, wherein a size of the first portions is based on a first preliminary granularity level;
determining a first performance metric associated with migrating the first subset;
migrating a second subset of the memory of the VM, wherein migrating the second subset comprises tracking a dirtiness of second portions of the second subset, and wherein a size of the second portions is based on a second preliminary granularity level;
determining a second performance metric associated with migrating the second subset; and
based on the first performance metric and the second performance metric, determining the granularity level.

13. The apparatus of claim 12, wherein determining the granularity level comprises selecting one of the first preliminary granularity level or the second preliminary granularity level.

14. The apparatus of claim 12, wherein at least one of the first performance metric and the second performance metric comprises a migration speed.

15. The apparatus of claim 12, wherein at least one of the first performance metric and the second performance metric comprises a processing resource usage.

16. The apparatus of claim 9, wherein determining the granularity level comprises selecting a default granularity level.

17. The apparatus of claim 9, wherein the instructions further cause the processor to:
generate a tracking data structure, wherein tracking the portions of the memory of the VM for dirtiness comprises recording, in the tracking data structure, page-level dirtiness of the memory of the VM.

18. The apparatus of claim 17, wherein the instructions further cause the processor to:
generate a page-level tracking data structure, wherein tracking the portions of the memory of the VM for dirtiness comprises recording, in the tracking data structure, page identifiers of pages of the memory of the VM which include the dirtied portions.

19. The apparatus of claim 9, wherein the instructions further cause the processor to:
update the granularity level based on tracking portions of the memory of the VM for dirtiness.

20. The apparatus of claim 19, wherein updating the granularity level comprises:
determining a number of sub-pages of a page of the VM that are dirtied; and
based on the number of dirtied sub-pages exceeding a threshold, reducing the granularity level.

21. The apparatus of claim 19, wherein updating the granularity level comprises:
determining a number of contiguous sub-pages of a page of the VM that are dirtied; and
based on the number of contiguous dirtied sub-pages exceeding a threshold, reducing the granularity level.

22. An apparatus comprising a processor and a non-transitory, computer-readable memory comprising instructions which, when executed by the processor, cause the processor to:
determine an expected level of dirtiness of a memory of the VM;
based on the expected level of dirtiness of the memory of the VM, determine a granularity level for tracking the memory of the VM; and
track portions of the memory of the VM for dirtiness, wherein a size of the portions is based on the granularity level.
